(19) United States
(12) Patent Application Publication
(10) Pub. No.: US 2011/0048640 A1
(43) Pub. Date: Mar. 3, 2011

(54) METHOD FOR PRODUCING CIRCUIT CARRIERS

(75) Inventors: Helmut Heinz, Ansbach (DE); Bernhard Schuch, Neusitz (DE)

(73) Assignee: CONTI TEMIC MICROELECTRONIC GMBH, Nurnberg (DE)

(21) Appl. No.: 12/922,712

(22) PCT Filed: Jan. 28, 2009
(86) PCT No.: PCT/DE09/00115

§ 371 Date: Nov. 18, 2010

(30) Foreign Application Priority Data
Mar. 18, 2008 (DE) 10 2008 014 690.0

(51) Int. Cl. B29C 65/52; B32B 37/12; H01B 1/22

(52) U.S. Cl. 156/330; 156/60; 252/512; 252/514

(57) ABSTRACT

A method for the automated production of circuit carriers, comprising providing a substrate for accommodating electronic components, applying an electrically conductive, metal-containing base structure on the substrate. Electronic components are also provided on the substrate and are connected to each other by the structure. Electrically conductive, metal-containing conductive adhesive structures are applied onto the substrate, and the electronic components are connected to the base structure in an electrically conductive way by the structures. The conductive adhesive structures are optically differentiated from the base structure by a colored electrically conductive, metal-containing conductive adhesive applied onto the substrate in order to produce the conductive adhesive structure. A contrast, which is necessary for the automated optical monitoring of the conductive adhesive structures and the base structure, is established between the conductive adhesive structures and the base structure.

The invention relates to a method for the production of circuit carriers and an electrically conductive, silver-containing conductive adhesive for use in such a method according to the preamble of the independent claims.

On circuit carriers, as they are used for example in control devices for the automotive industry, a metal-containing, electrically conductive base structure such as conductor paths and/or contact pads is applied in particular in thick-film or also thin-film technology for contacting electronic components which inter alia consist of silver-containing materials.

Beside these silver-containing materials also other metal-containing materials are possible for producing the conductive base structure, which likewise appear silver-colored. The contacting of electronic components with these metallic, electrically conductive base structures is often effected with electrically conductive adhesives, wherein here predominantly epoxy resin adhesives with a filling of silver or other metal particles, for example nickel, are used as conductive adhesive.

Since in the production of the circuit carriers the degree of automation is very high, there is inter alia the demand to detect the conductive adhesive structures produced by applying the conductive adhesive onto the circuit carrier and the base structure by means of an automatic optical inspection, for example a camera or an x-ray apparatus, and to control their position and outlines.

Due to an identical or similar coloration of the metallic base structure and the conductive adhesive the contrast usually is too weak to differentiate the conductive adhesive structures from the base structure.

On the part of the manufacturers of conductive adhesives there are efforts to color the resin adhesive with dark pigments, such as for the example soot.

However, the disadvantage of this method is that the resin adhesive constitutes only approx. 20% of the conductive adhesive and, therefore, large amounts of pigments would be necessary to cause a significant color change of the adhesive. On the other hand, large amounts of aggregates can in turn adversely affect the electrical properties of the conductive adhesive.

It is, therefore, the object of the invention to create a method for the automatic production of circuit carriers according to the preamble of claim 1 while using an electrically conductive metallic conductive adhesive according to the preamble of Claim 8 which enables a reliable automated optical detection and control both of the base structure and of the conductive adhesive structures.

This object is achieved according to invention by a method with the features indicated in claim 1 while using an electrically conductive, metallic conductive adhesive with the features of claim 8.

In the following, for the sake of simplicity conductive shall mean electrically conductive. It is the core of the invention that for an automated optical monitoring of the conductive, metal-containing conductive adhesive structures and the conductive, metal-containing base structure on the substrate, the conductive adhesive structures are optically differentiated from the base structure in that a colored conductive, metal-containing conductive adhesive is applied onto the substrate in order to produce a conductive adhesive structure. Thus a contrast, which is necessary for the automated optical monitoring of the conductive adhesive structures and the base structure, is established between the conductive adhesive structures and the base structure. Such an automated optical monitoring serves for reducing the costs of production.

As substrates in particular thick-film ceramics, low-temperature co-fired ceramics, so-called LTCCs, or organic circuit boards are used, on which the base structure is applied for example in thick-film or thin-film technology. Circuit paths or contact pads are exemplary for the base structure.

Advantageously, the electrically conductive, metal-containing conductive adhesive comprises a polymer matrix and metal particles, wherein the metal particles are exposed to a reaction gas before being placed into the polymer matrix and thus are dark colored. Thus, the conductive adhesive structures produced on the substrate with the conductive adhesive can be optically differentiated from the base structure.

As a reaction gas usually oxygen or a sulfur-containing gas is used and the metal particles consist in particular of silver, as silver has a high electrical conductivity.

Further advantages and features of the invention will become apparent from the ensuing description of an example of embodiment on the basis of drawing, in which

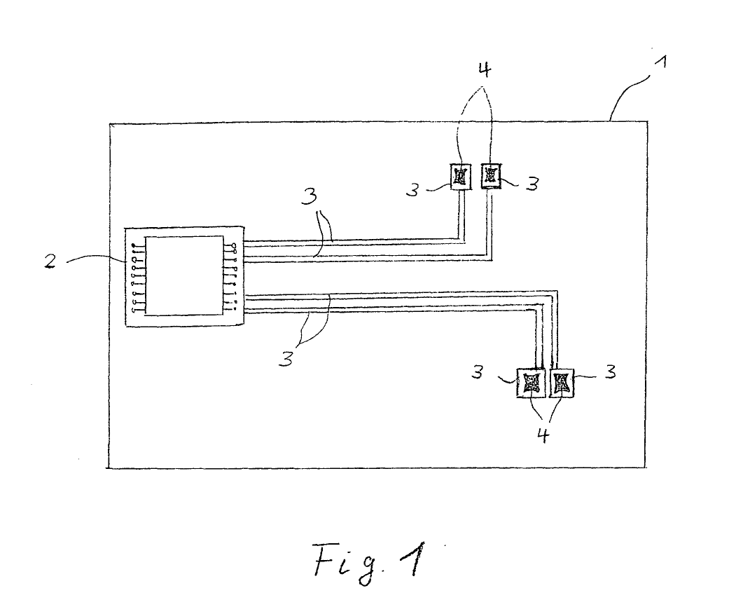

FIG. 1 shows a circuit carrier with base structure and conductive adhesive structures.

FIG. 1 shows a circuit carrier with a substrate 1 for accommodating electronic components 2, for the example a chip. The electronic components 2 can electrically connected with each other by means of a conductive, metal-containing base structure 3 applied on the substrate 1. Here, the base structure 3 comprises conductor paths and contact pads for accommodating electronic components 2.

On the substrate 1, in particular on the base structure 3, conductive, metal-containing conductive adhesive structures 4 are applied preferably in thin or thick film technology, the electronic components 2 being connected to the base structure 3 in an electrically conductive way by said structures. In this case conductive adhesive structures 4 with a pulvinated surface are applied onto the contact pads 3. When placing the electronic components 2 onto the contact pads 3 this shall avoid the conductive adhesive emerging beyond a contact pad 3 and causing a short circuit between adjacent contact pads 3.

To allow for an automated optical monitoring of the conductive, metal-containing conductive adhesive structures 4 and the conductive, metal-containing base structure 3 on the substrate 1, the conductive adhesive structures 4 must be optically distinguishable from the base structure 3.

For this purpose a colored conductive, metal-containing conductive adhesive is used for producing the conductive adhesive structures 4. Thus, a contrast, which is necessary for the automated optical monitoring of the conductive adhesive structures 4 and the base structure 3 is established between the conductive adhesive structures 4 and the base structure 3.

Generally, the conductive adhesive comprises a polymer matrix, for example an epoxy resin, with additionally placed in metal particles, in particular silver particles.

For coloring the conductive adhesive the epoxy resin is not changed; likewise the portion of silver particles, which are responsible for the electrical conductivity, is maintained.

The anyway used silver particles are changed in color by chemical reaction at their surface such that all in all a significant color change, in particular a dark coloring is effected. In practice, this can be realized for example by exposing the silver particles before they are placed into the polymer matrix to a reaction gas, which by reaction with the silver particles on the surface there generates a dark precipitation. This can be achieved for example by reaction of the silver with oxygen or sulfur-containing gases, such as e.g. sulfur dioxide.

Silver oxide and/or silver sulfide are produced as reaction products on the surface, what there generates a dark, nearly black precipitation. These reaction products are located merely at the surface of the silver particles in a very small layer thickness. By the dark reaction products mentioned in the example the electrical conductivity is not significantly reduced, so that all in all neither an increased volume resistance, nor an increased transition resistance is to be expected. As the conductive adhesive consists to approx. 80% of silver particles, with this method a complete darkening is achieved. In this way, the contrast, which is necessary for the automatic optical inspection, can be re-established between the base structure 3 and the conductive adhesive structures 4.

The present invention was illustrated on the basis of the foregoing description to explain the principle of the invention and its practical application in the best possible way. However, the invention can be realized with suitable modification naturally in numerous other forms of embodiment.

### REFERENCE NUMERALS

1 Substrate
2 Electronic component
3 Electrically conductive, metal-containing base structure
4 Electrically conductive, metal-containing conductive adhesive structures

1.-11. (canceled)

12. A method for the automated production of circuit carriers, the method comprising:
applying an electrically conductive, metal-containing base structure on a substrate for accommodating electronic components, the electronic components on the substrate being connected to each other by said base structure,
applying electrically conductive, metal-containing conductive adhesive structures onto the substrate, the electronic components being connected to the base structure in an electrically conductive way by said adhesive structures,
wherein the adhesive structures are produced from a colored electrically conductive, metal-containing conductive adhesive such that a contrast is established between the conductive adhesive structures and the base structure.

13. The method according to claim 12, wherein a thick-film ceramic is used as the substrate.

14. The method according to claim 12, wherein a low-temperature co-fired ceramic (LTCC) is used as the substrate.

15. The method according to claim 12, wherein the base structure defines conductor paths and/or contact pads.

16. The method according to claim 12, wherein the electrically conductive, metal-containing base structure is applied in thick film technology onto the substrate.

17. The method according to claim 12, wherein the electrically conductive, metal-containing base structure is applied in thin film technology onto the substrate.

18. The method according claim 12, wherein the electrically conductive, metal-containing conductive adhesive is an epoxy resin adhesive with a filling of silver particles.

19. An electrically conductive, metal-containing conductive adhesive for use in a method according to claim 12, wherein the conductive adhesive comprises a polymer matrix and metal particles, wherein the metal particles are exposed to a reaction gas before being placed into the polymer matrix and are thus dark colored.

20. An electrically conductive, metal-containing conductive adhesive according to claim 19, wherein the reaction gas is oxygen.

21. An electrically conductive, metal-containing conductive adhesive according to claim 19, wherein the reaction gas is a sulfur-containing gas.

22. An electrically conductive, metal-containing conductive adhesive according claim 19, wherein the metal particles are silver particles.
